(19) United States
(12) Patent Application Publication
(10) Pub. No.: US 2026/0192364 A1
(43) Pub. Date: Jul. 9, 2026

(54) METHOD OF DETERMINING PROCESS PARAMETERS FOR LASER POWDER BED FUSION ADDITIVE MANUFACTURING

(71) Applicant: KATHOLIEKE UNIVERSITEIT LEUVEN, Leuven (BE)

(72) Inventors: Louca GOOSSENS, Aarschot (BE); Lars VANMUNSTER, Heverlee (BE)

(21) Appl. No.: 19/130,703

(22) PCT Filed: Nov. 16, 2023
(86) PCT No.: PCT/EP2023/082062

§ 371 Date: May 16, 2025

(30) Foreign Application Priority Data
Nov. 16, 2022 (EP) 22207724.0

(51) Int. Cl. B22F 10/85; B22F 10/28; B22F 10/366; B33Y 10/00; B33Y 50/02

(52) U.S. Cl. CPC B22F 10/85; B22F 10/28; B22F 10/366; B33Y 10/00; B33Y 50/02

(57) ABSTRACT

A method is for controlling a device for additive manufacturing arranged to perform an LPBF process. The method includes determining a set of control parameters to control the device for additive manufacturing by providing a set of thermophysical properties of the powder to be used, a set of parameters specific to the device including a laser spot size, and a target layer thickness for a layer to be produced in the LPBF process.

### FIELD OF THE INVENTION

The present invention is generally related to methods for determining process parameters for a laser powder bed fusion additive manufacturing (LPBF) process.

### BACKGROUND OF THE INVENTION

Laser powder bed fusion (LPBF) additive manufacturing works by passing a laser over a powder bed along a predefined path such that the laser melts the powder and fuses it to make a solid part of a product. The product is progressively built up in layers of preset thicknesses. Machines for performing laser powder bed fusion are sold with sets of process parameters for specific layer thicknesses. The process parameters are determined by the machine manufacturers based on the settings of the machines and are highly determinative of the quality of the output product; users cannot set their own custom layer thicknesses without extensive trials and experimentation to determine the optimal parameter sets.

The process parameters generally include laser power, laser scan speed, laser spot size, inter track distance (hatch).

The ability to vary the layer thickness while building a single piece is advantageous because this improves the surface quality, especially for highly curved shapes due to the staircase effect, and shortens the production time. By determining layer thicknesses for each build layer depending on the surface normal at that layer, the build process can be optimised by, for example, setting the layer thickness to a relatively large value for parts of the product which have a small surface normal (thus decreasing the time taken to build that part of the product, as compared to needing to conform to a preset maximum layer thickness). The build process and surface quality can be further optimised by implementing multiple layers of relatively smaller thickness for parts of the product with larger surface normal (staircase effect).

In order to implement such a varying layer thickness scheme, the ability to set a custom layer thickness and corresponding process parameters is needed. A user may wish to use layer thicknesses which are different to those set by the machine manufacturer in order to achieve a more accurate result.

In US2022/219239 A1 a method for determining alloy processing parameters is provided. Simulated melt pool temperature and melt pool geometries can be used to create an initial printability map based on laser speed and laser power, and the printability map can include regions with potential manufacturing defects. The occurrence of these defects determines the boundaries of the printability map. In this way a set of acceptable laser speed/power combinations is obtained while certain other combinations are excluded. Experiments can be used to calibrate the printability map. The disclosed method so basically yields a set of combinations that lead to ‘good’ processing parameters for a given layer thickness and laser spot size.

There is therefore a need for accurate and fast methods for determining process parameters for a given layer thickness to be used in an additive manufacturing process, which do not require extensive experimentation and testing on LBPF devices.

### SUMMARY OF THE INVENTION

It is an object of embodiments of the present invention to provide for a computer-implemented method for deriving control parameters to control a device for additive manufacturing arranged to perform an LPBF process.

The above objective is accomplished by the solution according to the present invention.

In a first aspect the invention relates to a computer-implemented method for controlling a device arranged to perform a laser powder bed fusion, LPBF, additive manufacturing process. The method comprises determining a set of control parameters to control said device by
providing a set of thermophysical properties of the powder to be used, a set of parameters specific to said device including at least a laser spot size, and a target layer thickness for a layer to be produced in the LPBF process;
modelling a laser melt pool as a half ellipsoid shape with melt pool depth d and melt pool width w, wherein consecutive laser passes have a separation x, and determining a value for the separation x which yields a maximum amount of added net molten material in a single laser pass;
expressing that determined value of the separation x as a function of melt pool depth;
solving the separation expression for laser power and scan speed subject to the target layer thickness and the Plateau-Rayleigh criterion, by deriving from said set of parameters specific to the device a plurality of pairs of laser power and scan speed, obtaining for each pair melt the pool width w, melt pool length l and melt pool aspect ratio R from the melt pool model comprising said set of parameters including said laser spot size and said thermophysical properties, calculating d as d=R·w, and finding a pair of laser power and scan speed values that satisfies the Plateau-Rayleigh criterion and said target layer thickness,
deriving from the obtained values for laser power and scan speed the set of control parameters to control the device.

It is an advance of embodiments of the present invention that, by making use of the Rayleigh Plateau criterion, the separation expression can be fully solved resulting in a custom laser power and scan speed for a specific layer thickness for the device with which the LPBF process is going to be performed.

Advantageously, the set of control parameters are applied while performing the additive manufacturing process.

The laser spot size may be chosen as a function of the target layer thickness.

The separation expression may be solved using a parameter search method wherein the target layer thickness is constrained depending on boundaries of the device. In some embodiments these boundaries are user-defined. For example, a minimum layer thickness value may amongst others be based on the size and quality of the powder particles in a layer and a maximum value may be chosen to still achieve an acceptable surface quality.

If the parameter search method results in multiple solutions for the separation expression, an optimal solution may be chosen by comparing each of the multiple solutions based on an optimization criterion and selecting the solution that meets best the optimization criterion.

The optimization criterion may be the build rate. Alternatively, the optimization criterion is the density of the resulting layer. In yet other embodiments the optimization criterion is the cooling rate of the melt pool.

The identified laser power and scan speed may be used to determine a resulting melt pool width.

A contour may be provided for the layer to be produced and an offset for the contour may be determined depending on the laser power and scan speed.

In one embodiment the method may comprise a step of determining whether the obtained laser power and scan speed are suitable for a particular application and, if the obtained values are not suitable, adjusting the laser spot size and repeating the method as previously described.

In a second aspect of the present invention there is provided a method of performing adaptive hatching comprising providing a set of layer thicknesses and associated contours; and determining the laser power and scan speed for each layer thickness using the method as described.

In a preferred embodiment the method may comprise determining a hatch spacing for the set of layers, wherein the hatch spacing is dependent on the melt pool width.

In another aspect of the invention there is provided a computer program comprising instructions which, when the program is executed by a computer, cause the computer to carry out the steps of the method as described above.

In yet a further aspect of the invention a computer-readable medium is provided comprising instructions which, when executed by a computer, cause the computer to carry out the steps of the method as previously described.

For purposes of summarizing the invention and the advantages achieved over the prior art, certain objects and advantages of the invention have been described herein above. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

The above and other aspects of the invention will be apparent from and elucidated with reference to the embodiment(s) described hereinafter.

### BRIEF DESCRIPTION OF THE DRAWINGS

The invention will now be described further, by way of example, with reference to the accompanying drawings, wherein like reference numerals refer to like elements in the various figures.

FIG. 1 illustrates a flowchart of a method according to embodiments of the present invention.

FIG. 2 is a schematic illustration of modelling of the melt pool as a half ellipsoid shape. It also shows how the position of the half ellipsoid shapes can be adjusted.

FIG. 3 illustrates a modified version of FIG. 2 showing how the net amount of added material can be determined.

FIG. 4 is a flowchart of an adaptive slicing method which may be part of a method according to embodiments of the present invention.

FIG. 5 is a conceptual illustration of the problem of contour offsetting.

FIG. 6 illustrates a side-by-side comparison microscope images of cross-sections of two half spheres built using processing parameters calculated using a method according to embodiments of the present invention.

FIG. 7 illustrates a microscope image of a cross-section of a further half-sphere built using processing parameters calculated using a method according to embodiments of the present invention.

### DETAILED DESCRIPTION OF ILLUSTRATIVE EMBODIMENTS

The present invention will be described with respect to particular embodiments and with reference to certain drawings but the invention is not limited thereto but only by the claims.

Furthermore, the terms first, second and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the invention described herein are capable of operation in other sequences than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

It should be noted that the use of particular terminology when describing certain features or aspects of the invention should not be taken to imply that the terminology is being re-defined herein to be restricted to include any specific characteristics of the features or aspects of the invention with which that terminology is associated.

In the description provided herein, numerous specific details are set forth. However, it is understood that embodiments of the invention may be practiced without these specific details. In other instances, well-known methods, structures and techniques have not been shown in detail in order not to obscure an understanding of this description.

The present invention concerns a method of determining a set of process parameters for a laser powder bed fusion process, based on a target layer thickness.

In a laser powder bed fusion (LPBF) additive manufacturing process, a product is built up progressively in layers by passing a high power laser beam over a powder bed along a predetermined path. The path is determined by first slicing a CAD model of the product to be produced into a series of layers, creating a two-dimensional cross section of each layer. The laser path for each layer is determined based on various parameters such as the hatch spacing, which specifies the distance between successive passes of the laser, and the melt pool size, such that the full 2D cross section is covered.

The powder is distributed on a substrate plate which can be translated in a vertical direction (essentially parallel to the direction of incidence of the laser beam). The laser forms a melt pool of liquid material when incident on the powder, which then fuses together to form a solid structure once cooled. Once a layer has been formed, the substrate is moved incrementally downward and a new layer of powder is applied for the subsequent layer. The process takes place in an atmosphere of inert gas.

For a given LPBF process, a set of process parameters are used. These define at least the power of the laser, the scan speed of the laser, the hatch spacing, and the layer thickness.

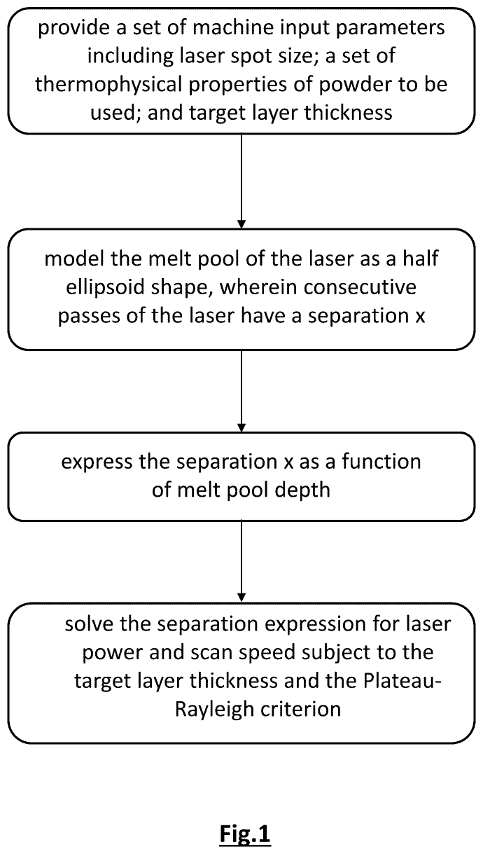

Referring to FIG. 1, a flowchart shows the steps of a method according to embodiments of the present invention for determining process parameters for forming a single layer based on the target layer thickness of that layer. The steps are as follows:

### Step S1

First, a set of input parameters is provided. The set of input parameters can be divided into two categories:
machine specific properties of the device used to perform the LPBF process, comprising the laser spot size, and optionally the minimum and maximum layer thickness capabilities, the gas flow direction, and pre-heating temperature;
thermophysical material properties for the material to be used for the LPBF process, comprising the melting temperature Tm [K]; the evaporation temperature Tb [K]; the density ρ [kg/m3]; the heat conductivity k [W/mK]; the heat capacity C [J/kgK]; the absorption coefficient A at the wavelength of the laser used in the LPBF process; and optionally the solidus temperature Tsol [K], the liquidus temperature Tliq [K], and the latent heat of fusion (at Tm) Lf [J/m3] These last three parameters are not necessary in order for the method to work but the accuracy of the output can be improved by including these parameters.

A target layer thickness for a layer to be produced is also provided. The target layer thickness is preferably determined based on the curvature of the product to be produced at the location where the layer is to be formed, as will be described in more detail hereinafter.

### Step S2

In step S2, the laser melt pool is modelled. The melt pool formation is influenced by the laser power, the scan speed and the radius of the laser beam. These three parameters determine the energy that is injected into the powder bed during the LPBF process. Additionally, the melt pool formation is influenced by the accumulation of heat in the substrate, which is related to the hatch spacing and the layer thickness.

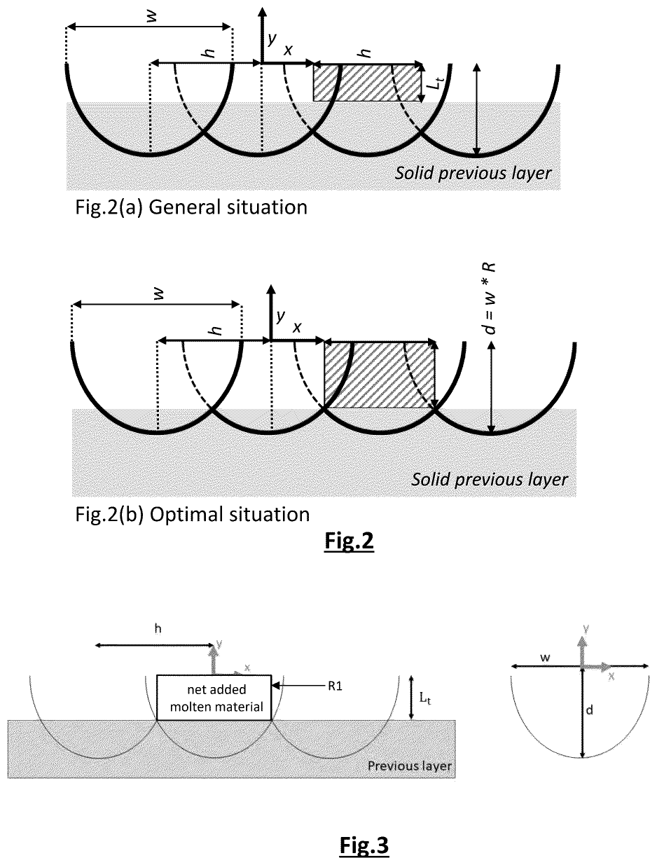

Referring to FIG. 2, the melt pool is modelled as a half ellipsoid shape, with the longer radius equal to the melt pool depth d and the shorter radius equal to the melt pool width w divided by 2. The equation of the ellipse can be written according to equation 1:

$$\frac{4 {x}^{2}}{{w}^{2}} + \frac{{y}^{2}}{{d}^{2}} = 1 \qquad ( 1 )$$

where x ranges from −w/2 to w/2 and y ranges from 0 to −d, since the melt pool is represented by half of the ellipse. This equation can be rewritten so that a value for y is obtained in function of x, according to equation 2:

$$y = - \sqrt{{d}^{2} - 4 {x}^{2} {R}^{2}} \qquad ( 2 )$$

where R=d/w is the aspect ratio of the melt pool.

The positions of the various half ellipsoid shapes can be adapted by positioning the shapes more upwards or downwards along the Y-axis (whereby the part of the half ellipsoide shapes that lies ‘in’ the previous solid layer, becomes smaller or bigger, respectively) and/or more to the left or right along the X-axis (whereby the spacing between consecutive tracks changes).

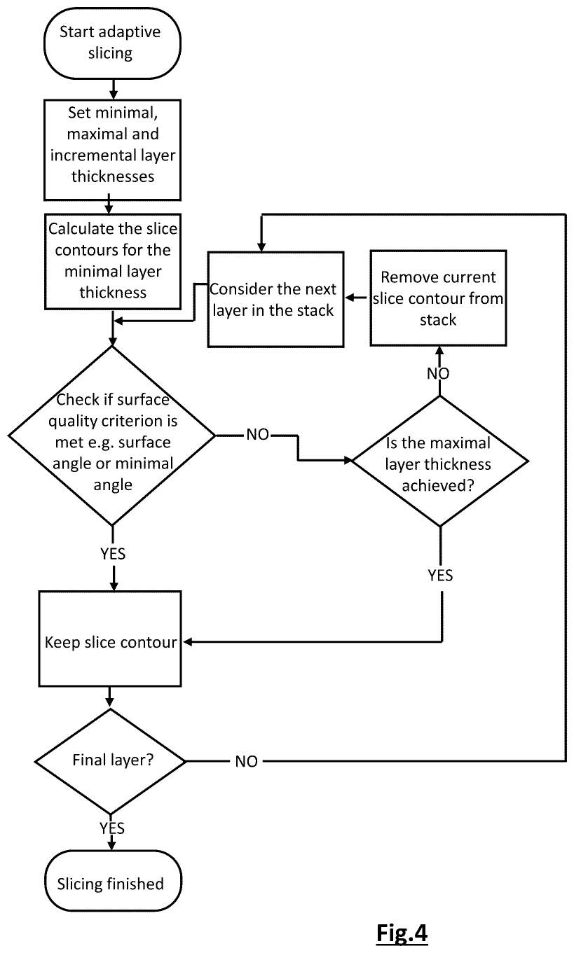

Referring to FIG. 2 and FIG. 3, a rectangle R1 is defined by the amount of molten material that is added when the laser scans a track on the powder bed. The figure shows there is overlap between consecutive melt pool tracks scanned by the laser and between adjacent layers, which helps to provide a good connection between layers and tracks. More specifically, rectangle R1 is formed by the thickness |y| of the newly added layer of molten material and the distance 2× between the crossing points of the considered half ellipsoid shape with its adjacent half ellipsoid shapes (i.e., the section on the x-axis where no overlap occurs with the adjacent melt pool tracks).

The area A of the rectangle R1 can be optimised by adapting the position of the half ellipsoide shapes. The area A can be expressed according to equation 3, making use of equation 2:

$$A = 2 x \vert y \vert = 2 x \sqrt{{d}^{2} - 4 {x}^{2} {R}^{2}} \qquad ( 3 )$$

### Step S3

In step S3, the separation x is expressed as a function of the melt pool depth d.

The build productivity is optimised when the area of rectangle R1 is maximal. The area A is maximised by setting the derivative of equation 3 with respect to x to zero. The values of x and y yielding the maximised area A are:

$$x = \sqrt{\frac{{d}^{2}}{8 {R}^{2}}} \qquad ( 4 )$$

$$y = - \frac{d \sqrt{2}}{2} \qquad ( 5 )$$

Thus the melt pool width is expressed as a function of the melt pool depth. The resulting rectangle with maximal area is shown on the right-hand side of FIG. 2

### Step S4

In step S4, the separation expression (equation 4) is solved for laser power and scan speed subject to the target layer thickness and the Rayleigh-Plateau criterion.

Revisiting FIG. 3, it can be seen that when the area of the rectangle is optimized, the absolute value of y is to be equated to the layer thickness Lₜ and 2× should be equated to the hatch spacing h. Thus the layer thickness and hatch spacing can be expressed as:

$${L}_{t} = \frac{d}{\sqrt{2}} = \frac{wR}{\sqrt{2}} \qquad ( 6 )$$

$$h = \frac{w}{\sqrt{2}} \qquad ( 7 )$$

For a certain laser power and scan speed, the melt pool aspect ratio R and the melt pool width w are known from the analytical models.

The Rayleigh-Plateau instability criterion is used to derive a further equation:

$$l = π w \qquad ( 8 )$$

where I denotes the length of the melt pool. This criterion states that if the melt pool is too long with respect to its width, namely l/w>π, the melt pool becomes discontinuous, due to the fact that the surface tension is not high enough to hold the elongated melt pools together. The more elongated the melt pools become, the more probable balling will occur. This phenomenon breaks the continuous liquid melt pool and divides it in discrete particles of spherical shapes. This should be avoided since a continuous melt pool is a requirement for the LPBF process.

The layer thickness is known as it is provided as an input parameter in step S1.

Considering equation 6 and the Rayleigh-Plateau instability criterion, there are three parameters: w, R and l. The laser power and the scan speed determine the width, length, and depth of the melt pool; or, conversely, the width, length and depth of the melt pool are a function of the laser power and scan speed. Thus equation 6 and the Rayleigh-Plateau instability criterion form a system of two equations in two unknowns, which can be solved to obtain the unknown laser power and laser speed.

Equation 7 can be used to determine the hatch spacing. The four main process parameters (layer thickness, hatch spacing, laser power and scan speed) are then known without the need of exhaustive experimental work or computationally expensive numerical simulations.

The melt pool depth, length, and ratio can be expressed in terms of laser power and scan speed as follows. A set of pairs of laser power (P) and scan speed (v) values are taken which span the machine limits. With machine limits is meant the maximum output power of the device's laser and the maximum stable scan speed achievable with the scanner system of the device being employed. For each pair of P and v values, the following thermophysical properties of the material can be considered: the melting temperature Tm [K]; the evaporation temperature Tb [K]; the density ρ [kg/m³]; the heat conductivity k [W/mK]; the heat capacity C [J/kgK]. The process parameter considered is A (absorption coefficient at the wavelength of the laser used in the LPBF process). For each pair of P and v values, the melt pool width w and depth d are computed, for example using a conduction model as described in ‘Methodology and experimental validation of analytical melt pool models for laser powder bed fusion’ (V.Coen et al., Journal of Materials Processing Technology, 304:117547, 2022). The aspect ratio is computed, for example using a keyhole model as described in the same reference. The calculated width and ratio are used to compute the depth d of the melt pool via d=Rw.

A parameter search method can then be used to find a pair of P and v values which satisfy equation 6 and the Rayleigh-Plateau instability criterion. The parameter search method may result in multiple solutions, i.e., multiple pairs of P and v values are found within the boundaries of the device. In such a situation, an optimal solution may be chosen by checking a given optimisation criterion for each solution and selecting the solution that best matches the optimisation criterion.

The optimisation criterion may be, for example, the build rate, which can be quantified as proportional to the hatch multiplied by the scan speed and the layer thickness [mm³/s].

The optimisation criterion may be the density of the as-built part. The density may be determined empirically. For example, a range of calculated scan speeds can be used to build parts and the density of each part can be measured experimentally. Such measurements may be performed upfront, i.e., before the algorithm to determine parameters as described in this invention is performed. The scanning speed can next be plotted against the density to visualize the relationship. Degradation of the density is expected to start at a threshold scanning speed due to hydrodynamic phenomena. The scanning speed threshold can be used in the method as a criterion such that, when a solution is found which has the highest build rate of a set of solutions, it is checked whether the scanning speed is above or below the threshold. If the scanning speed is above the threshold, this solution is rejected and the next highest build rate is considered in the same way.

Alternatively, a series of parts of the product to be produced could be built with parameters calculated using a method as described hereinbefore, wherein for each part the Rayleigh-Plateau criterion is slightly relaxed by a specific factor for each part, possibly a different factor for different parts. This allows for higher processing speeds but with a reduced part quality. The resulting part densities are measured experimentally and plotted against the relaxation factor. A threshold can be found for the relaxation factor above which the density degrades. The threshold can be used in the same way as the scanning speed threshold described above.

It may be the case that no solutions are found for P and v within the machine parameters. If this situation occurs, the laser spot size can be adjusted and the parameter search repeated.

The optimisation criterion may be the cooling rate of the melt pool. The cooling rate scales inversely with the size of the melt pool, i.e., a larger melt pool results in a smaller cooling rate. This optimisation criterion may be particularly advantageous for difficult to weld materials which suffer from hot cracking, e.g., some types of aluminium alloy, hastelloy X, nickel super-alloys or in applications in which the microstructure needs to be tailored.

The method as described hereinbefore relates to the calculation of a single layer thickness. In practice, it is generally desirable to vary the layer thickness throughout the build process. The method according to embodiments of the present invention can be used in conjunction with an adaptive slicing method to provide a fully custom parameter and layer thickness determination process.

First, an adaptive slicing process is performed. Referring to FIG. 4, the adaptive slicing process comprises the following steps. A CAD model of the part to be built is provided. A minimal, maximal, and incremental layer thickness are set. These thicknesses tend to be machine dependent and so may be set depending on the machine type/model. The laser spot size and available laser power influence the maximal layer thickness and so these can be taken into consideration as well. Then the CAD model is sliced into layers having the minimal layer thickness. Next, for each layer in turn, it is determined whether a surface quality criterion is met. The surface quality criterion may be, for example, based on the average surface angle for the considered vertical position or the minimum of the surface angles for the considered vertical position (see also FIGS. 2 and 3).

If the surface quality criterion is not met, it is checked whether the current layer thickness is equal to the maximal layer thickness. If so, the slice contour is kept; if not, the slice contour is removed from the stack and the next layer in the stack is merged with the current layer. This merged layer is used for the check on the surface quality criterion in the following iteration.

If the slice contour is kept, the method continues by setting the layer thickness for the layer corresponding to the slice contour, and then moving on to the next layer in the stack. More iterations are performed until the final layer is reached. The output of the adaptive slicing method is a set of slice contours and corresponding layer thicknesses.

In some embodiments, the part to be built may be subdivided into quality sections, i.e. sections where differing quality values are allowed. For example, lower quality/higher porosity (and therefore faster production speed) may be allowable in component sections which are not subject to critical loads. Thus, in these sections a higher layer thickness may be allowable as compared to critical sections (higher quality). Load-bearing sections may be restricted to higher quality values to ensure performance.

The parameter determination method according to embodiments of the present invention can then be used for each layer thickness in turn to determine the optimal process parameters for each layer. In this way, full flexibility is maintained over the layer thickness such that the surface quality of the part can be optimized.

In some applications, adaptive slicing is not needed but a custom layer thickness different to those provided by the machine manufacturer is desired, for example for reasons of efficiency or build quality. In such situations the method according to embodiments of the present invention can be used with the custom layer thickness(es) as input in order to determine the LPBF process parameters.

The laser spot size, normally being a fixed process parameter used as input in step S1, can in some embodiments be chosen as a function of the target layer thickness, since larger laser spot sizes are generally more suitable for larger layer thicknesses. For example, a range of suitable laser spot sizes can be defined as the machine value comparable to or in the same magnitude as the layer thickness.

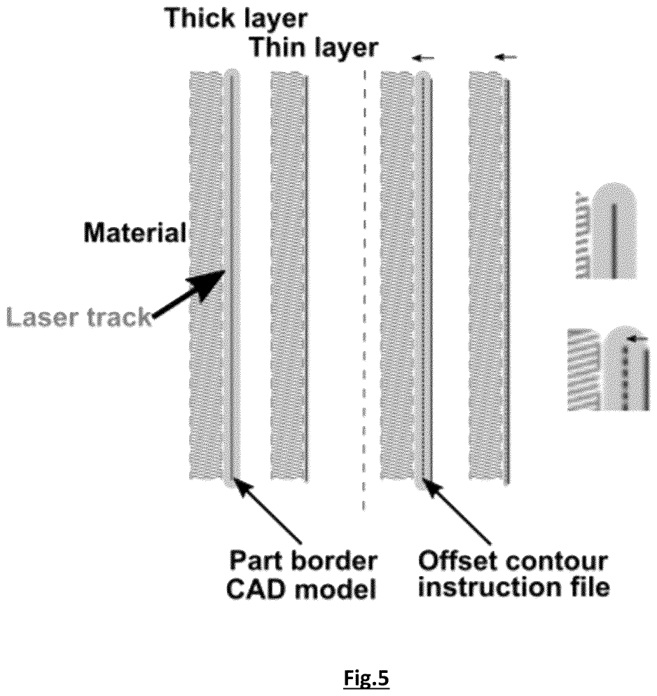

Methods according to embodiments of the present invention may include a contour offsetting step. A contour is a laser scan path around the perimeter of the part, required for part accuracy and quality. If the contour position remains fixed, the as-built part would be too big (for outer contours) and too small (for inner contours), by half the track width in each case. This can be seen in FIG. 5. To compensate for the track width, the part contour can be offset inwards or outwards. Normal slicing only has one fixed contour offset, because uniform parameters are applied throughout the part, and the track width should be consistent. For adaptive slicing, the contour needs to be offset depending on the layer thickness. This is due to the track width varying with the layer thickness: different process parameters are used depending on the layer thickness, as calculated using the methods described herein. This results in a different track width for each layer thickness. Therefore, in embodiments of the present invention, an additional step may be performed as part of the parameter search. The contour offset is expressed as a function of the laser power and scan speed, and the melt pool length is also expressed as a function of the laser power and scan speed using the Rayleigh-Plateau criterion. The contour offset is fixed as being half the track width and then the equations can be solved for the target width. If multiple P, v pairs are output from the parameter search, an optimal pair can be determined for example by finding the pair with the lowest laser power in order to optimise the surface finish.

### EXAMPLE IMPLEMENTATION

All components are built on the LM-Q, an in-house developed LPBF machine. The LM-Q works with a 1080 nm fibre laser with a default laser spot size of 37.5 micron (variable due to an additional focusing unit) and a maximum laser power of 1 kW. In these examples 316L stainless steel is used. The powder feedstock material is obtained through gas atomization. The particle size ranges between 15 and 53 micron. Note however that this is merely one example of a possible material and use of other materials can be envisaged. The approach proposed in this invention can readily be applied when the appropriate thermophysical input parameters for the material under consideration have been provided.

The examples shown are half spheres with a radius of 10 mm. The half sphere has a continuously varying outward normal vector, which forces the adaptive slicing algorithm to use the full user-selected layer thickness range (for example, 10 to 100 μm in increments of 10 μm, without being limited thereto).

Two half-spheres were built, with the processing parameters calculated using a method as described hereinbefore, where each calculation had slight modifications to equations 6 to 8 as shown in the following table:

| Half-sphere 1 | Half-sphere 2 |
|---|---|
| ${L}_{t} = \frac{wR}{2 \sqrt{2}}$ | ${L}_{t} = \frac{wR}{2.2 \sqrt{2}}$ |
| ${h}_{R < 1.5} = \frac{w}{\sqrt{2}} , {h}_{R > 1.5} = \frac{w}{1.2}$ | $h = \frac{w}{1.2}$ |
| l = 2.5w | l = πw |

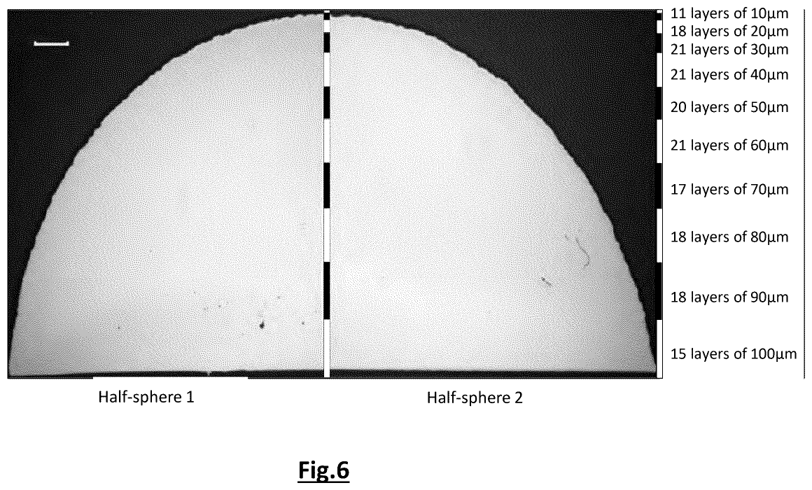

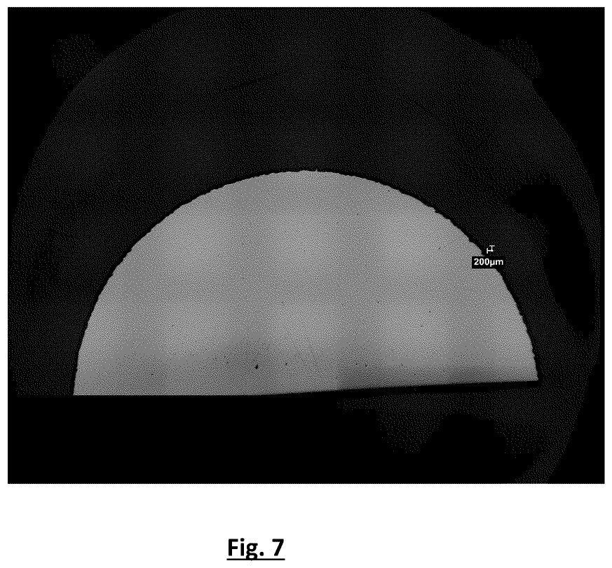

FIG. 6 shows a comparison of half-sphere 1 and half-sphere 2. The number of layers built at each layer thickness is shown at the side of the figure. The optical densities of the half-spheres were measured after production. The spheres were sliced vertically, i.e. in a direction parallel to the normal of the flat face of the half sphere, and imaged by a microscope (Keyence VHX-600). Under such imaging, pores in the part appear black and the material of the part itself appears white. The area of the black pores is calculated relative to the area of the white material of the part. This gives the optical density. Further description of the optical density method can be found in the paper “Optical Metallography” (M. R. Louthan, Mater. Charact., vol. 10, pp. 299-308, 2018, doi: 10.31399/asm.hb.v10.a0001754.

An optical density of 99.4% is measured for half-sphere 1 and 99.97% for half-sphere 2. It can be seen that the surface is smooth and represents the shape of a half sphere accurately in both cases.

FIG. 7 shows a half-sphere built with the processing parameters calculated using a method as described hereinbefore, using unmodified equations 6 to 8. The optical density was measured to be 99.92%. Advantageously, such a method does not require a “calibration” by progressive modification of equations 6 to 8.

The methods described herein may be implemented on a computer. For example, a method according to embodiments of the present invention may be implemented on a computer which includes a memory and a processor and is adapted to receive input data, for example through a wired or wireless connection. The processor may be adapted to carry out steps of a method as described herein and the memory may store the parameters.

While the invention has been illustrated and described in detail in the drawings and foregoing description, such illustration and description are to be considered illustrative or exemplary and not restrictive. The foregoing description details certain embodiments of the invention. It will be appreciated, however, that no matter how detailed the foregoing appears in text, the invention may be practiced in many ways. The invention is not limited to the disclosed embodiments.

Other variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1.-14. (canceled)

15. A computer-implemented method for controlling a device arranged to perform a laser powder bed fusion, LPBF, additive manufacturing process, the method comprising determining a set of control parameters to control said device for additive manufacturing by:
providing a set of thermophysical properties of the powder to be used, a set of parameters specific to said device including at least a laser spot size, and a target layer thickness for a layer to be produced in the LPBF process;
modelling a laser melt pool as a half ellipsoid shape with melt pool depth d and melt pool width w, wherein consecutive laser passes have a separation x, and determining a value for the separation x which yields a maximum amount of added net molten material in a single laser pass;
expressing said determined value of the separation x as a function of melt pool depth;
solving the separation expression for laser power and scan speed subject to the target layer thickness and the Plateau-Rayleigh criterion, by deriving from said set of parameters specific to said device a plurality of pairs of laser power and scan speed, obtaining for each pair the melt pool width w, melt pool length l and melt pool aspect ratio R from the melt pool model comprising said set of parameters including said laser spot size and said thermophysical properties, calculating d as d=R·w, and finding a pair of laser power and scan speed values that satisfies the Plateau-Rayleigh criterion and said target layer thickness;
deriving from the obtained values for laser power and scan speed said set of control parameters to control said device.

16. The method according to claim 15, comprising a step of determining whether the obtained laser power and scan speed are suitable for a particular application and, if the obtained values are not suitable, adjusting the laser spot size and repeating the step of determining said set of control parameters.

17. The method according to claim 15, wherein said separation expression is solved using a parameter search method wherein said target layer thickness is constrained depending on boundaries of said device.

18. The method according to claim 17, wherein, if the parameter search method results in multiple solutions for said separation expression, an optimal solution is chosen by comparing each of the multiple solutions based on an optimization criterion.

19. The method according to claim 18, wherein the optimization criterion is the build rate.

20. The method according to claim 18, wherein the optimization criterion is the density of the resulting layer.

21. The method according to claim 18, wherein the optimization criterion is the cooling rate of the melt pool.

22. The method according to claim 15, wherein said obtained values for laser power and scan speed are used to determine a resulting melt pool width.

23. The method according to claim 15, wherein, for the layer to be produced, a contour is provided and an offset for the contour is determined depending on the laser power and scan speed.

24. The method according to claim 15, wherein the laser spot size is chosen as a function of the target layer thickness.

25. A method of performing adaptive hatching comprising:
providing a set of layer thicknesses and associated contours; and
determining the laser power and scan speed for each layer thickness using the method according to claim 15.

26. The method according to claim 25, further comprising determining a hatch spacing for the set of layers,
wherein the hatch spacing is dependent on the melt pool width.

27. A computer program comprising instructions which, when the program is executed by a computer, cause the computer to carry out the steps of the method of claim 15.

28. A computer-readable medium comprising instructions which, when executed by a computer, cause the computer to carry out the steps of a method according to claim 15.
